(19) United States
(12) Patent Application Publication
(10) Pub. No.: US 2020/0180174 A1
(43) Pub. Date: Jun. 11, 2020

(54) Multipurpose vehicular emergency tool

(71) Applicant: Xinyan Zhang, Wynnewood, PA (US)

(72) Inventor: Xinyan Zhang, Wynnewood, PA (US)

(21) Appl. No.: 16/597,842

(22) Filed: Oct. 9, 2019

Related U.S. Application Data
(60) Provisional application No. 62/743,262, filed on Oct. 9, 2018.

(51) Int. Cl. B26B 11/00; H02J 7/00; A62B 3/00

(52) U.S. Cl. CPC B26B 11/008; A62B 3/005; H02J 7/0042; B26B 11/006

(57) ABSTRACT

A multipurpose vehicular emergency tool has a power source and a plurality of electrical outputs sufficient to act as a jump-starter for a vehicle or to charge mobile electronic devices, in addition to powering a light source to act as a flashlight. A plurality of emergency tools are provided, including a seatbelt cutter and a window breaker, in order to facilitate one's safety and survival in an emergency vehicular situation. Additional features include an emergency flasher light, a plurality of reflective bands, a compass, an emergency alarm, and a thermometer.

The current application claims a priority to the U.S. Provisional Patent application Ser. No. 62/743,262 filed on Oct. 9, 2018.

### FIELD OF THE INVENTION

The present invention relates generally to electricity storage. More particularly, the present invention relates to multipurpose power banks.

### BACKGROUND OF THE INVENTION

In present times individuals are always looking for practical and modular multi-purpose tools. In conventional systems, power banks and jump boxes that are stowed away in car compartments are often bulky, making them hard to store, and are often hard to handle, especially in emergency situations.

The present invention aims to improve on the conventional systems. The present invention is a multi-functional tool that features the ergonomics of a flashlight, while providing essential emergency functions. The present invention provides illumination for emergency situations, particularly for signaling purposes. The present invention can also provide power to car batteries, cell phones, laptops, and/or any other type of electronic device. The present invention is also compact and ergonomic, allowing it to be stowed away in a smaller compartment, such as a cupholder or glove box. The present invention is also robust, water resistant, and shockproof, allowing it to be used as an emergency hand tool for breaking glass, and/or cutting seatbelts.

Additional advantages of the invention will be set forth in part in the description which follows, and in part will be obvious from the description, or may be learned by practice of the invention. Additional advantages of the invention may be realized and attained by means of the instrumentalities and combinations particularly pointed out in the detailed description of the invention section. Further benefits and advantages of the embodiments of the invention will become apparent from consideration of the following detailed description given with reference to the accompanying drawings, which specify and show preferred embodiments of the present invention.

### BRIEF DESCRIPTION OF THE DRAWINGS

FIG. 1 is a front raised perspective view of the present invention.

FIG. 2 is a rear lowered perspective view of the present invention.

FIG. 3 is a diagram illustrating the electrical connections of the present invention.

FIG. 4 is a front raised perspective view of an alternate embodiment of the present invention showing the lighting aperture.

FIG. 5 is an illustration of an electrical output cable interfacing with the present invention.

FIG. 6 is a front lowered perspective view of the present invention with the window breaker and the seatbelt cutter in the deployed position.

FIG. 7 is a raised side perspective view of the head portion of one embodiment of the head portion of the housing.

FIG. 8 is a lowered perspective view of the one embodiment of the head portion of the head portion of the housing.

FIG. 9 is a front raised perspective view of another embodiment of the head portion of the housing.

FIG. 10 is front raised perspective view of another embodiment of the head portion of the housing.

FIG. 11 is a perspective exploded view of one embodiment of the present invention.

FIG. 12 a perspective exploded view of the preferred embodiment of the present invention.

FIG. 13 a rear view of one embodiment of the present invention.

### DETAIL DESCRIPTIONS OF THE INVENTION

All illustrations of the drawings are for the purpose of describing selected versions of the present invention and are not intended to limit the scope of the present invention. The present invention is to be described in detail and is provided in a manner that establishes a thorough understanding of the present invention. There may be aspects of the present invention that may be practiced or utilized without the implementation of some features as they are described. It should be understood that some details have not been described in detail in order to not unnecessarily obscure focus of the invention. References herein to “the preferred embodiment”, “one embodiment”, “some embodiments”, or “alternative embodiments” should be considered to be illustrating aspects of the present invention that may potentially vary in some instances, and should not be considered to be limiting to the scope of the present invention as a whole.

The present invention is a multipurpose vehicular emergency tool. More particularly, the present invention is a handheld device useful for storing electricity in order to jump start a vehicle and charge electronic devices, in addition to providing vehicle-related emergency tools. The present invention is a multi-functional tool that features the ergonomics of a flashlight, while providing essential emergency functions. The modular present invention provides illumination for emergency situations, particularly for signaling purposes. The present invention can also provide power to car batteries, cell phones, laptops, and/or any other type of electronic device. The present invention is also compact and ergonomic, allowing it to be stowed away in a smaller compartment, such as a cupholder or glove box. The present invention is also robust, water resistant, and shockproof, allowing it to be used as an emergency hand tool for breaking glass, and/or cutting seatbelts. In general, the present invention should be constructed to be durable and rugged, being water resistant, dirt resistant, shock resistant, and slip resistant.

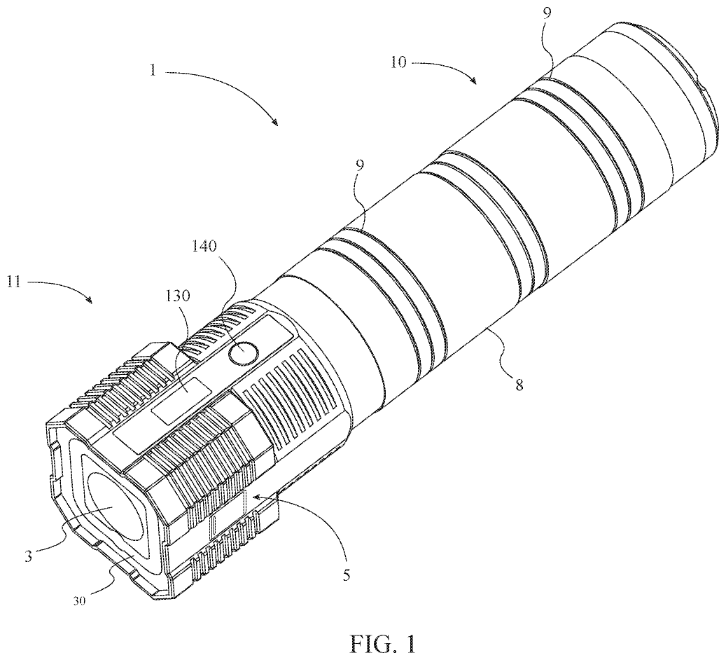

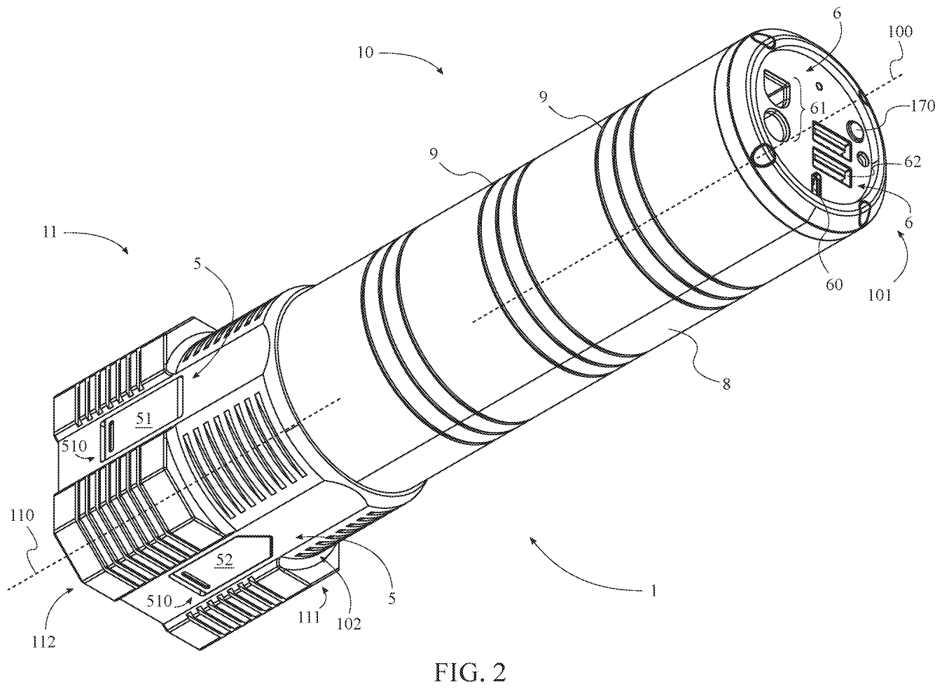

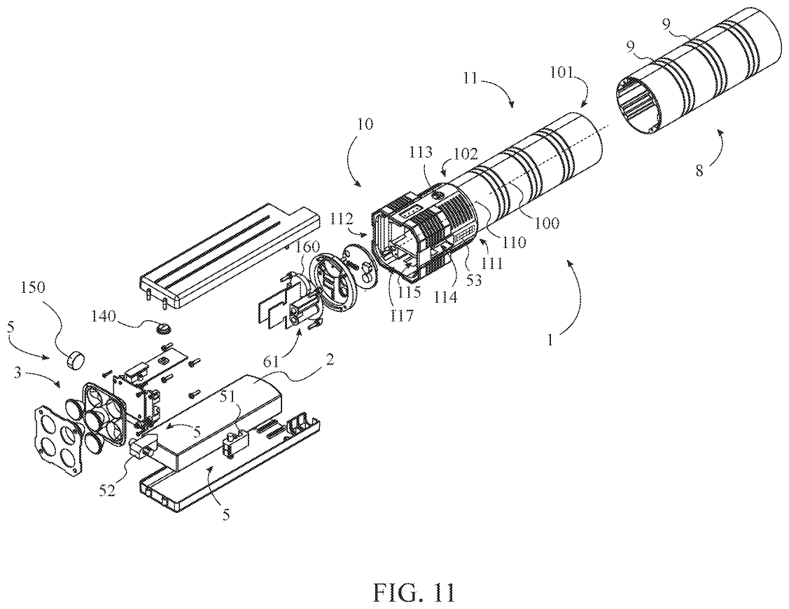

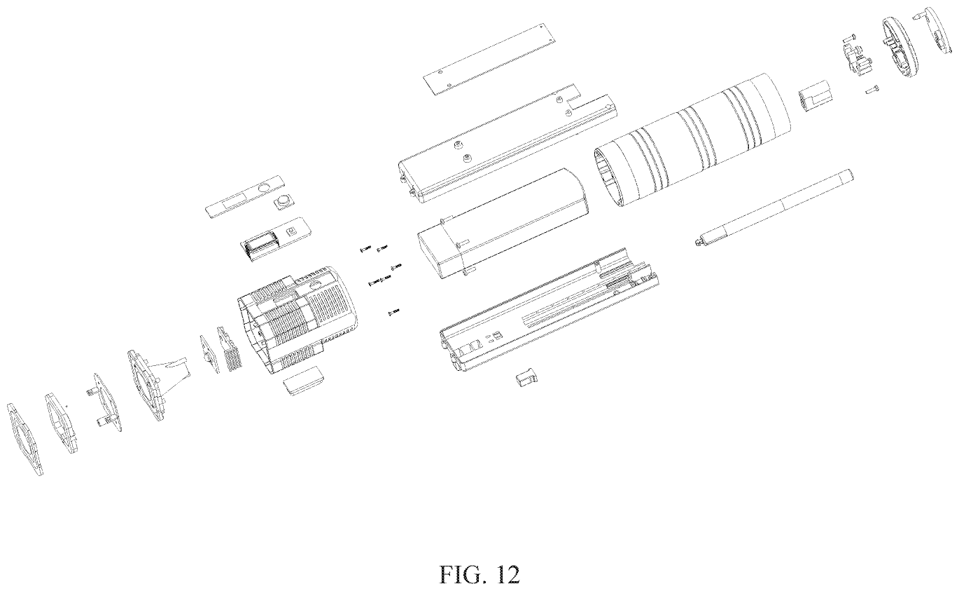

In general, referring to FIGS. 1-2, the present invention comprises a housing 1, a power source 2, a light source 3, a controller 4, a plurality of emergency tools 5, and a plurality of electrical outputs 6. FIGS. 11-12 show exploded perspective views of the present invention. In the preferred embodiment of the present invention, the plurality of emergency tools 5 comprises a seatbelt cutter 51 and a window breaker 52. Furthermore in the preferred embodiment, the plurality of electrical outputs 6 comprises a vehicle jump start output 61 and at least one charging output 62. The plurality of emergency tools 5 is connected to the housing 1, and are readily available to the user should the need to use them arise.

The housing 1 is the main body of the present invention, More specifically, the housing 1 serves as the main structural and mounting agent of the present invention that houses, secures, and protects the rest of the components of the present invention. The housing 1 may be manufactured of any desirable material, though it is preferable that the housing 1 be manufactured from such materials and through such manufacturing processes as to make the housing 1 durable and robust.

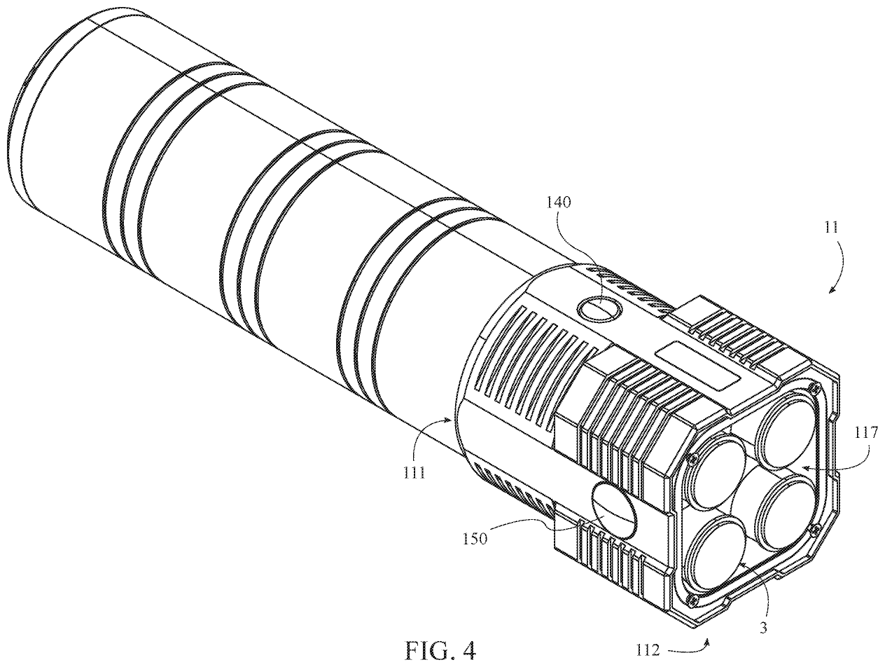

In the preferred embodiment, the housing 1 comprises a body portion 10 and a head portion 11, with the body portion 10 and the head portion 11 being connected adjacent to each other, and the light source 3 being connected to the head portion 11 of the housing 1 opposite the body portion 10. The head portion 11 extends axially between a proximal end 111 and a distal end 112 as shown in FIG. 2, wherein the proximal end 111 of the head portion 11 is connected adjacent to the body portion 10. Similarly, the body portion 10 axially extends between a proximal end 101 and a distal end 102, wherein the distal end 102 of the body portion 10 is connected adjacent to the proximal end 111 of the head portion 11. As shown in FIG. 4, the head portion 11 further comprises a lighting aperture 117 that traverses axially into the head portion 11 through the distal end 112 of the head portion 11, providing a space for the light source 3 to project light outward from the present invention. The present invention is shown in FIG. 4 with a lighting cover of the head portion 11 removed, wherein the lighting cover is included to occupy empty lateral space between the light source 3 and the head portion 11 of the housing 1 in order to create a substantially flat surface as seen in FIG. 1. The light source 3 is mounted within the head portion 11 of the housing 1 adjacent to the distal end 112 of the head portion 11, wherein the light source 3 is oriented away from the proximal end 111 of the head portion 11 through the lighting aperture 117. A light activation switch 140 is electrically connected to the controller 4, and preferably traverses though the head portion 11 of the housing 1 adjacent to the proximal end 111 of the head portion 11. The light activation switch 140 may primarily control actuation of the light source 3 to use the present invention as a flashlight, or the light activation switch 140 may additionally control other lighting components of the present invention.

In the preferred embodiment, the plurality of electrical outputs 6 are connected to the proximal end 101 of the body portion 10 as shown in FIG. 2, though this should not be considered a requirement, and in various embodiments, the location of various electrical outputs 6 from the plurality of electrical outputs 6 may vary as desired and useful. Furthermore, in the preferred embodiment, an electrical input 60 is also connected to the proximal end 101 of the body portion 10, wherein the electrical input 60 is used to charge the power source 2 or potentially to electronically interface with the present invention through an external computing device.

Furthermore, in the preferred embodiment, the body portion 10 of the housing 1 has cylindrical geometry, such that the body portion 10 comprises a central axis 100. Moreover, the head portion 11 is connected axially adjacent to the body portion 10, such that the head portion 11 also comprises a central axis 110, and is positioned relative to the body portion 10 such that the central axis 110 of the head portion 11 and the central axis 100 of the body portion 10 are positioned collinear with each other. In some embodiments, the head portion 11 has generally rectangular geometry, though the geometry of the head portion 11 may vary in different embodiments. It is generally desired, however, that the body portion 10 has cylindrical geometry in order to facilitate an ergonomic grip for the user. It is contemplated that in some embodiments, the body portion 10 may comprise further ergonomic features, such as, but not limited to, finger receptacles or curvilinear geometry which may enhance the ergonomic aspect.

Additionally, the preferred embodiment further comprises a frictional sleeve 8 that is connected around the body portion 10 of the housing 1, such that the body portion 10 is sleeved by the frictional sleeve 8. The frictional sleeve 8 may be made of rubber or another suitable frictional material, and may further comprise physical features such as knurling, bumps, ridges, and/or similar features to promote a sturdy hand-held grip by the user. Moreover, the preferred embodiment of the present invention further comprises a plurality of reflective bands 9. In some embodiments omitting the frictional sleeve 8, the plurality of reflective bands 9 is externally connected to the housing 1. In some embodiments, the plurality of reflective bands 9 is externally connected to the frictional sleeve 8. Preferably, the reflective bands 9 encircle the perimeter of the frictional sleeve 8, allowing the user to more easily find the present invention should the user lose awareness of its location.

The controller 4 is configured to regulate electrical flow from the power source 2 to the light source 3, the plurality of electrical outputs 6, and any other component or feature of the present invention which may require electrical power. The controller 4 is electrically connected to the power source 2, the light source 3, and any other electrical components of the present invention.

The power source 2 is positioned within the housing 1 and provides electricity storage for purposes such as illuminating the light source 3, jump starting a vehicle, and charging electronic devices, among other uses. In various embodiments of the present invention, the power source 2 may take any suitable form necessary to fulfill its intended functionality. More particularly, the power source 2 should have at least enough electrical storage capacity to jump start a typical passenger vehicle, in some embodiments, the power source 2 is a battery or combination of batteries capable of storing 8000 milli-amp hours (mAh) of electricity. Moreover, the power source 2 should be capable of delivering at least 300 amps of electrical current for vehicular jump-starting purposes. In the preferred embodiment, the power source 2 can provide 1000 amps of current. The power source 2 may utilize any suitable battery chemistry, or alternatively or additionally may comprise a super capacitor as useful and desired.

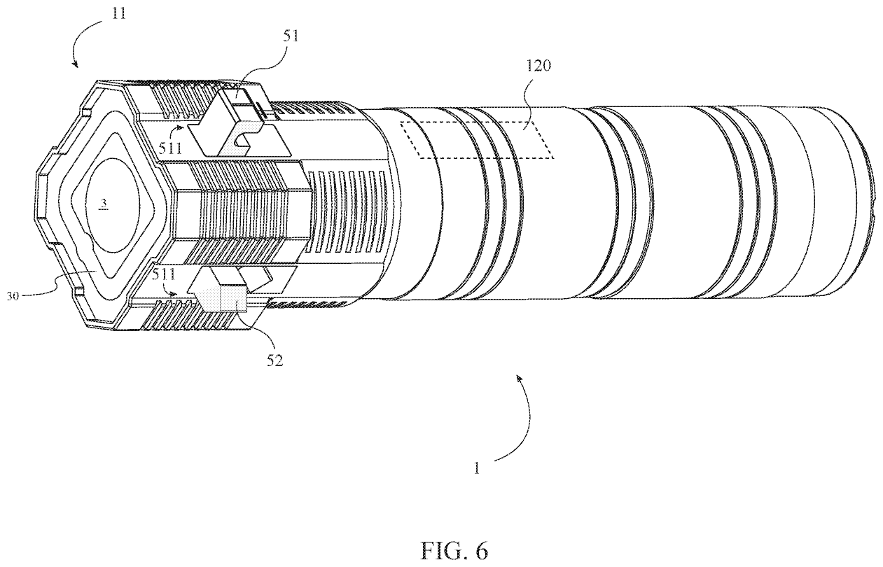

It is contemplated that the light source 3 of the present invention may take many different forms and may utilize various configurations and components as deemed suitable. The light source 3 should provide a significantly bright beam, and in the preferred embodiment has a brightness rating of at least 300 lumens. In some embodiments, the light source 3 comprises a single bulb. In some embodiments, the light source 3 comprises a plurality of bulbs arranged together. For example, in some embodiments, the light source 3 comprises four bulbs arranged into a 2×2 grid, as exemplified in FIG. 4. Furthermore, in such embodiments, the light source 3 may be subdivided into a primary white light source and a secondary light source colored red or having other differentiating features from the primary light source 3. Further still, in some embodiments, the light source 3 may comprise an emergency flasher light source 30 that is separated from the main light source 3, as shown in FIGS. 1 and 6. For example, the emergency flasher light source 30 may be strip-style light source 3 that surrounds the primary light source 3, and may provide a different color of illumination from the primary light source 3; for example, the emergency flasher light source 30 may be yellow in color. The emergency flasher light source 30 may be configured to actuate on and off in various patterns; for example, in a Morse Code “SOS” pattern, or in a strobe pattern, or in any other desired pattern. The embodiment shown in FIG. 1 may be considered to be the preferred embodiment of the present invention with respect to the configuration of the light source 3, with the single main light source surrounded by the emergency flasher light source 30, while the embodiment wherein the light source 3 comprises multiple bulbs arranged into a grid as described above and shown in FIG. 4 may be considered to be an alternative embodiment of the present invention.

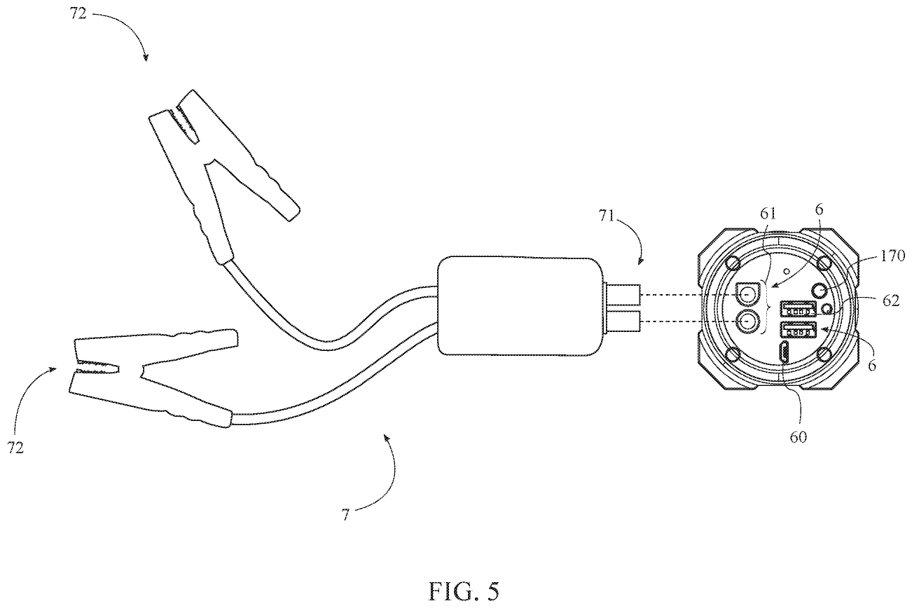

Referring to FIG. 5, in the preferred embodiment of the present invention, an electrical cable 7 is further provided in order to enable the vehicular jump-start functionality of the present invention. A first end 71 of the electrical cable 7 may be removably engaged with the vehicle jump start output 61, while a second end 72 of the electrical cable 7 may comprise a pair of battery terminal clamps. A user must connect the first end 71 of the electrical cable 7 to the vehicle jump start output 61 and the second end 72 to the battery terminals of a vehicle they wish to jump start.

In the preferred embodiment, the seatbelt cutter 51 and the window breaker 52 are each integrated into the head portion 11 of the housing 1, though their respective positioning may vary in different embodiments. More particularly, referring to FIGS. 2 and 6, the seatbelt cutter 51 and the window breaker 52 are both deployably connected to the housing 1, wherein the seatbelt cutter 51 and the window breaker 52 are each selectively positionable between a stored position 510 and a deployed position 511. Even more particularly, the seatbelt cutter 51 and the window breaker 52 are hingedly connected to the housing 1, being recessed into the housing 1, preferably flush or within the outer axial perimeter of the housing 1 in the stored position 510, and extended laterally outward, or oriented perpendicular to the central axis 110 of the head portion 11 in the deployed position 511.

In the preferred embodiment, for both the seatbelt cutter 51 and the window breaker 52, each may comprise a pair of opposing pins that are engaged into corresponding support structures in the housing 1, in brackets or other elements within the housing 1, or other relevant areas. The pins enable the seatbelt cutter 51 and the window breaker 52 to rotate outward into the deployed position 511 for use. The seatbelt cutter 51 comprises a blade mount and a blade, the blade mount comprising a blade cavity, within which the blade is positioned as typical with existing seatbelt cutters. The window breaker 52 should comprise a protrusion that comes to a point, and should be made out of a hard material in order to enable breaking a window of a vehicle in order to escape the vehicle if the need arises.

The preferred embodiment of the present invention further comprises at least one magnet 120. The at least one magnet 120 may be internally connected to the housing 1, or at any desirable and useful location on the present invention. The at least one magnet 120 should be an industrial strength magnet, or at least have a strong enough magnetic field to magnetically affix the present invention to any ferromagnetic object or surface.

The preferred embodiment of the present invention further comprises a battery gauge 130 in order to view the current level of charge of the power source 2, as seen in FIG. 1. The battery gauge 130 is electrically connected to the power source 2, and is seated within the housing 1 and exposed through the housing 1 so as to be observable to the user. The battery gauge 130 may be positioned at any desirable location on the present invention, though in the preferred embodiment the battery gauge 130 is positioned on the head portion 11 of the housing 1, adjacent to or near the light activation switch 140.

The preferred embodiment of the present invention further comprises a compass 150, as shown in FIG. 4. The compass 150 is connected adjacent to the housing 1, wherein the compass 150 is exposed for viewing through the housing 1. Alternatively, compass 150 may be exteriorly connected to the housing 1.

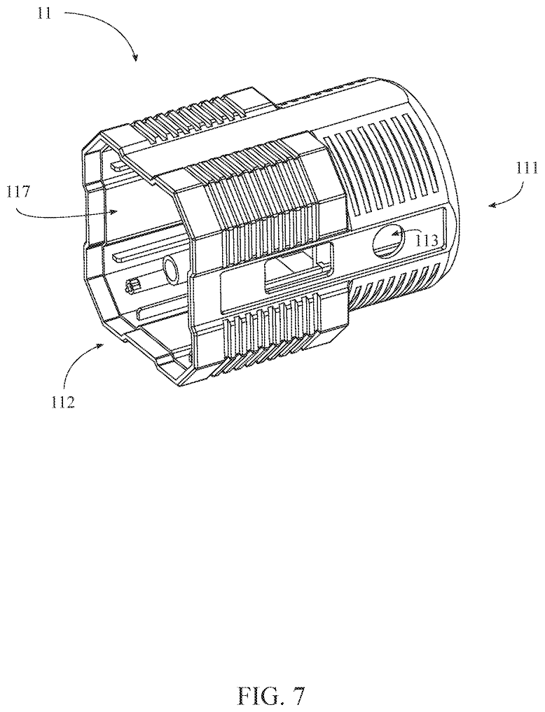

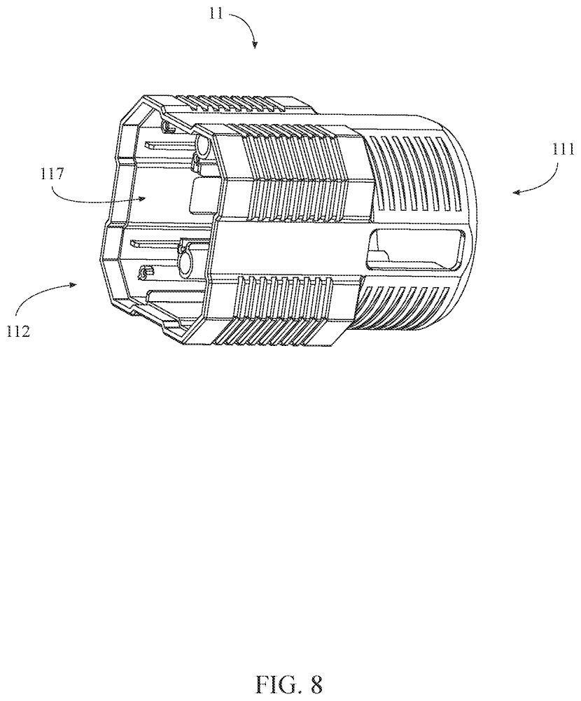

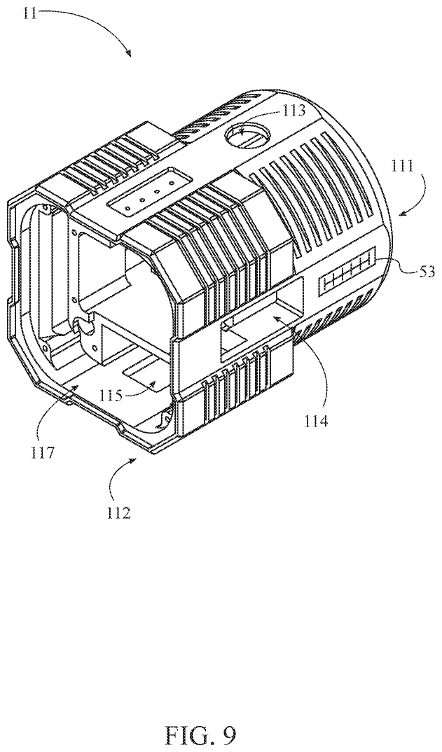

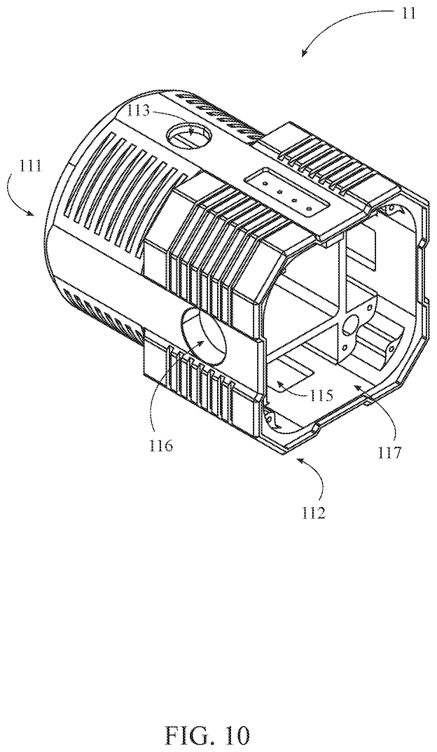

Referring to FIGS. 9-10, in the preferred embodiment, the head portion 11 of the housing 1 comprises a switch opening 113, a cutter opening 114, a window breaker 52 opening 115, and a compass 150 opening 116 in the preferred embodiment. The switch opening 113, the cutter opening 114, the window breaker 52 opening 115, and the compass 150 opening 116 laterally traverse through the head portion U. The light activation switch 140 traverses through the switch opening 113. The seatbelt cutter 51 is hingedly connected within the cutter opening 114, the window breaker 52 is hingedly connected within the window breaker 52 opening 115, and the compass 150 is positioned within the compass 150 opening 116. Though it is contemplated that the specific positioning of the aforementioned openings are not of particular importance to the functionality of the present invention, in the preferred embodiment the aforementioned openings are positioned at right angles to each other on the head portion 11, each being positioned on one side of the generally rectangular geometry of the head portion 11. FIGS. 7-8 show an alternative embodiment for the head portion 11.

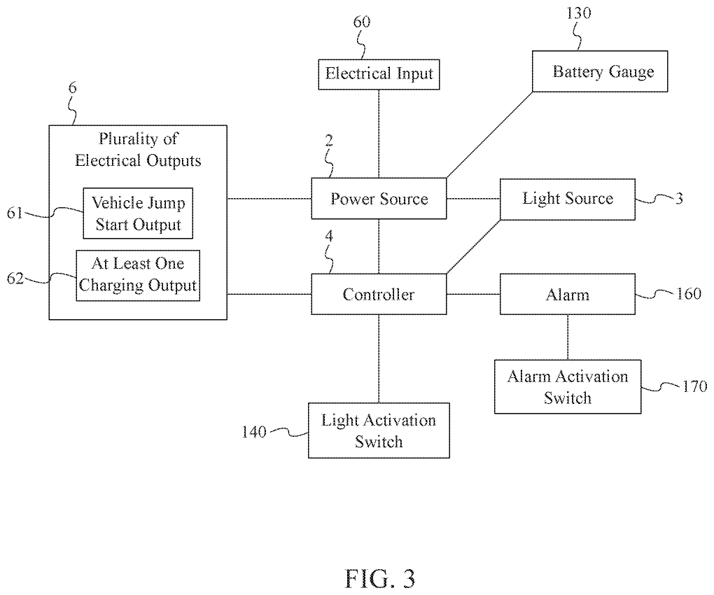

The preferred embodiment of the present invention further comprises an alarm 160 and an alarm activation switch 170. The alarm 160 is connected adjacent to the housing 1, and preferably comprises an alarm 160 grille, though the alarm 160 may be positioned in any feasible and desirable location on the present invention. The alarm 160 may comprise any suitable sound producing device, preferably capable of producing loud, attention-grabbing sounds. The alarm 160 is electrically connected to the controller 4 and the alarm activation switch 170, as illustrated in FIG. 3. The alarm activation switch 170 is preferably positioned at the proximal end 101 of the body portion 10 of the housing 1, adjacent to the plurality of electrical outputs 6, as shown in FIG. 5, When a user engages the alarm activation switch 170, an alarm sound may be played through the alarm 160.

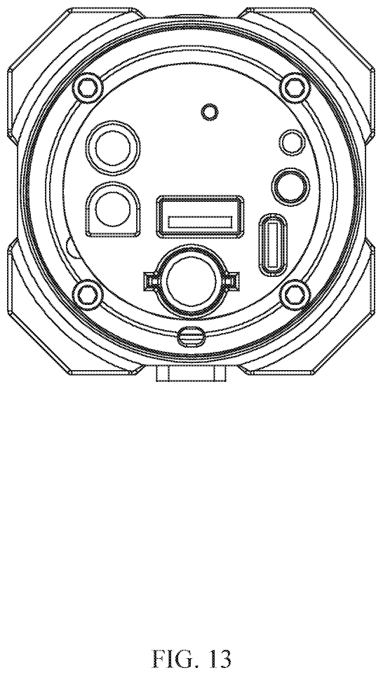

The preferred embodiment of the present invention further comprises a thermometer 53 that is connected to the housing 1, as shown in FIGS. 9 and 11, such that the thermometer 53 is exposed through the housing 1, wherein the thermometer 53 may be embedded within the external surface of the housing 1, or the thermometer 53 may be affixed to the exterior of the housing 1. The thermometer 53 adds yet another feature to the present invention which may be relevant to one's safety and survival in an emergency situation. Various other emergency tools 5 may be further provided in various embodiments, such as, but not limited to, a length of rope, a hook, or other relevant tools or features. FIG. 12 shows an exploded view of the preferred embodiment, wherein FIG. 11 may be considered to be an alternate embodiment. FIG. 13 shows a rear view of the preferred embodiment, wherein FIG. 5 may be considered to be an alternate embodiment.

Although the invention has been explained in relation to its preferred embodiment, it is to be understood that many other possible modifications and variations can be made without departing from the spirit and scope of the invention as hereinafter claimed.

What is claimed is:

1. A multipurpose vehicular emergency tool comprises:
a housing;
a power source;
a light source;
a controller;
a plurality of emergency tools comprising a seatbelt cutter and a window breaker;
a plurality of electrical outputs comprising a vehicle jump start output and at least one charging output;
the power source being positioned within the housing;
the plurality of emergency tools being connected to the housing;
the housing comprising a body portion and a head portion;
the body portion and the head portion being connected adjacent to each other;
the light source being connected to the head portion of the housing opposite the body portion; and
the controller being electrically connected to the power source, the light source, and the plurality of electrical outputs, wherein the controller is configured to regulate electrical flow from the power source to the light source and the plurality of electrical outputs.

2. The multipurpose vehicular emergency tool as claimed in claim 1 comprises:
an electrical cable;
a first end of the electrical cable being removably engaged with the vehicle jump start output; and
a second end of the electrical cable comprising a pair of battery terminal clamps.

3. The multipurpose vehicular emergency tool as claimed in claim 1 comprises:
the body portion having cylindrical geometry, wherein the body portion comprises a central axis; and
the head portion being connected axially adjacent to the body portion, wherein the head portion comprises a central axis, and wherein the central axis of the head portion and the central axis of the body portion are positioned collinear with each other.

4. The multipurpose vehicular emergency tool as claimed in claim 1 comprises:
the seatbelt cutter and the window breaker being integrated into the head portion.

5. The multipurpose vehicular emergency tool as claimed in claim 1 comprises:
the seatbelt cutter being deployably connected to the housing, wherein the seatbelt cutter is selectively positionable between a stored position and a deployed position.

6. The multipurpose vehicular emergency tool as claimed in claim 4 comprises:
the seatbelt cutter being hingedly connected to the housing, wherein the seatbelt cutter is oriented perpendicular to a central axis of the head portion in the deployed position.

7. The multipurpose vehicular emergency tool as claimed in claim 1 comprises:
the window breaker being deployably connected to the housing, wherein the seatbelt cutter is selectively positioned between a stored position and a deployed position.

8. The multipurpose vehicular emergency tool as claimed in claim 6 comprises:
the window breaker being hingedly connected to the housing, wherein the seatbelt cutter is oriented perpendicular to a central axis of the head portion in the deployed position.

9. The multipurpose vehicular emergency tool as claimed in claim 1 comprises:
a frictional sleeve; and
the frictional sleeve being connected around the body portion of the housing, wherein the body portion is sleeved by the frictional sleeve.

10. The multipurpose vehicular emergency tool as claimed in claim 1 comprises:
a plurality of reflective bands; and
the plurality of reflective bands being externally connected to the housing.

11. The multipurpose vehicular emergency tool as claimed in claim 1 comprises:
a plurality of reflective bands; and
the plurality of reflective bands being externally connected to a frictional sleeve, wherein the frictional sleeve is connected around the body portion of the housing.

12. The multipurpose vehicular emergency tool as claimed in claim 1 comprises:
the head portion extending axially between a proximal end and a distal end, wherein the proximal end of the head portion is connected adjacent to the body portion;
the head portion comprising a lighting aperture traversing axially into the head portion through the distal end of the head portion; and
the light source being mounted within the head portion of the housing adjacent to the distal end of the head portion, wherein the light source is oriented away from the proximal end of the head portion through the lighting aperture.

13. The multipurpose vehicular emergency tool as claimed in claim 1 comprises:
at least one magnet; and
the at least one magnet being internally connected to the housing.

14. The multipurpose vehicular emergency tool as claimed in claim 1 comprises:
a battery gauge;
the battery gauge being electrically connected to the power source; and
the battery gauge being seated within the housing and exposed through the housing.

15. The multipurpose vehicular emergency tool as claimed in claim 1 comprises:
a light activation switch;
the light activation switch traversing through the head portion of the housing adjacent to a proximal end of the head portion; and
the light activation switch being electrically connected to the controller.

16. The multipurpose vehicular emergency tool as claimed in claim 1 comprises:
a compass;
a light activation switch;
the head portion comprises a switch opening, a cutter opening, a window breaker opening, and a compass opening;
the switch opening, the cutter opening, the window breaker opening, and the compass opening laterally traversing through the head portion;
the light activation switch traversing through the switch opening;
the seatbelt cutter being hingedly connected within the cutter opening;
the window breaker being hingedly connected within the window breaker opening; and
the compass being positioned within the compass opening.

17. The multipurpose vehicular emergency tool as claimed in claim 1 comprises:
the body portion axially extending between a proximal end and a distal end, wherein the distal end of the body portion is connected adjacent to a proximal end of the head portion; and
the plurality of electrical outputs being connected to the proximal end of the body portion.

18. The multipurpose vehicular emergency tool as claimed in claim 1 comprises:
an alarm;
an alarm activation switch;
the alarm activation switch being connected adjacent to the housing, wherein the alarm activation switch is exposed through the housing;
the alarm being connected adjacent to the housing; and
the alarm being electrically connected to the controller and the alarm activation switch.

19. The multipurpose vehicular emergency tool as claimed in claim 1 comprises:
the plurality of emergency tools further comprising a thermometer; and
the thermometer being connected to the housing, wherein the thermometer is exposed through the housing.

20. The multipurpose vehicular emergency tool as claimed in claim 1 comprises:
the plurality of emergency tools further comprising a compass; and
the compass being connected adjacent to the housing, wherein the compass is exposed through the housing.
